(19) United States
(12) Patent Application Publication
(10) Pub. No.: US 2006/0293990 A1
(43) Pub. Date: Dec. 28, 2006

(54) APPARATUS, SYSTEM, AND METHOD FOR DETERMINING AND ACHIEVING A TAX ADVANTAGE THROUGH THE SPECIALIZED MANAGEMENT OF A PLURALITY OF CHARITABLE REMAINDER TRUSTS

(76) Inventor: Benson L. Schaub, Phoenix, AZ (US)

Correspondence Address: KUNZLER & ASSOCIATES, 8 EAST BROADWAY, SUITE 600, SALT LAKE CITY, UT, 84111, US

(21) Appl. No.: 11/462,629

(22) Filed: Aug. 4, 2006

Related U.S. Application Data
(63) Continuation-in-part of application No. 11/158,681, filed on Jun. 22, 2005.

(51) Int. Cl. G06F 17/22; G06Q 40/00; G07F 19/00

(52) U.S. Cl. 705/35; 705/31

(57) ABSTRACT

An apparatus, system, and method are disclosed for determining and achieving a tax advantage through the specialized management of a plurality of charitable remainder trusts (CRTs). In one embodiment, the apparatus includes an input module configured to receive client input, a calculation module configured to determine the projected income distribution and a corresponding tax requirement for a plurality of CRTs, a comparison module configured to determine and compare after-tax income generated for each of the plurality of CRTs, and a recommendation module configured to provide a recommended allocation of trust assets to a plurality of CRTs. The apparatus, system, and method may facilitate determining a recommended allocation of assets that provides the greatest tax advantage for income distributions issuing from a plurality of CRTs. The apparatus, system, and method may also integrate the client input and risk tolerance into the determination for the recommended allocation of trust assets in certain embodiments.

### CROSS-REFERENCES TO RELATED APPLICATIONS

This application is a continuation-in-part of and claims priority to U.S. patent application Ser. No. 11/158,681 entitled “SYSTEM AND METHOD FOR MAXIMIZING AFTER-TAX INCOME USING SPLIT METHOD CHARITABLE REMAINDER TRUSTS” and filed on Jun. 22, 2005 for Benson L. Schaub, which is incorporated herein by reference.

### BACKGROUND OF THE INVENTION

1. Field of the Invention

This invention relates to apparatuses, systems, and methods for estimating after-tax income and more particularly relates to apparatuses, systems, and methods for determining and achieving a tax advantage through the specialized management of a plurality of charitable remainder trusts (CRTs).

2. Description of the Related Art

A Charitable Remainder Trust (referring to either a Charitable Remainder Annuity Trust or a Charitable Remainder Unitrust and hereinafter referred to as a CRT) is a type of a deferred gift. The donor receives lifetime income and tax benefits and the gift to charities is deferred to a future time, usually the death of the donor or the end of a specified number of years. At the end of the designated time for income distributions, the trust terminates and the remainder left in the trust is distributed to one or more qualified charities. Under IRC section 664 income payments to a donor distributed by a charitable remainder trust shall be considered as having the following characteristics in the hands of a beneficiary:

“First, as amounts of income (other than gains, and amounts treated as gains, from the sale or other disposition of capital assets) includible in gross income to the extent of such income of the trust for the year and such undistributed income of the trust for prior years;

“Second, as a capital gain to the extent of the capital gain of the trust for the year and the undistributed capital gain of the trust for prior years;

“Third, as tax free income to the extent that there is tax free income to the trust for the year and the undistributed tax free income of the trust for prior years; and

“Fourth, as a return of principle.”

The foregoing provisions apply in the case of a charitable remainder annuity trust (CRAT) and a charitable remainder unitrust (CRUT). A charitable remainder annuity trust is a trust from which not less than 5 percent of the initial net fair market value of all property placed in trust is to be paid at least annually, generally as a fixed dollar amount, to one or more persons who are called income beneficiaries. Payments continue for a term of years (not in excess of 20 years) or for the life or lives of the beneficiaries. No other amount may be paid from the trust except to a charitable organization as described in section 170 C. Following the termination of the payments, the remainder interest in the trust is transferred to a charitable organization as described in section 170 C or is retained by the trust for such a use.

A charitable remainder unitrust is a trust from which a fixed percentage of no less than 5 percent of the net fair market value of its assets, valued annually, is to be paid, at least annually, to one or more income beneficiaries. Payment continues for a term of years (not in excess of 20 years) or for the life or lives of the beneficiaries. No other amount may be paid from the trust except to a charitable organization as described in section 170 C. Following the termination of the payments, the remainder interest in the trust is to be transferred to, or for the use of, an organization described in section 170 C or is to be retained by the trust for such a use. Charitable remainder annuity trusts and charitable remainder unitrusts themselves are generally not subject to any tax imposed by section 664.

The tiered treatment of the income distributions to the income beneficiary, first as ordinary income, second as capital gain, third as tax free income, and fourth as return of principle presents a potential tax disadvantage. Income generated within a CRT is taxed upon distribution. A CRT is required to first distribute any current or accumulated ordinary income that is within the trust. However, distribution of ordinary income is a disadvantage because of its relatively higher rate of taxation. The maximum tax rate for ordinary income is 35%, whereas the maximum capital gains rate is 15%.

Equity or growth investment income, the second tier, is taxed as capital gain. The disadvantage of investing in equity or growth investments, however, is the danger of market losses. Thus, equity investing is typically deemed to carry a higher risk. Perspectives on the best investment policy differ.

The lifetime income beneficiary might predictably favor a more aggressive, although higher risk, approach and capital gains tax treatment. Therefore, the income beneficiary would prefer the trustee to invest only in growth or equity investments. This is especially true for younger donors and/or income beneficiaries. However, trust assets may be depleted when equity or growth investments perform poorly and lose, rather than gain, value.

For example, if equity funds (in an all equity invested standard CRT) are down 10% for the year, the trustee is still required to make a full income distribution even if it has to come out of principle, which it does. A distribution out of the principle of the trust reduces the trust value and the eventual remainder value for the charity. The trust value could potentially spiral down if there are consecutive down market years.

Consequently, the charitable remainder beneficiary may favor conservation of trust assets through a lower risk approach. Fixed income investments are typically deemed to be safer, with a lower risk of loss. The remainderman, therefore, would rather see the trust invested in fixed income types of investments such as bonds, CDs, government securities, etc., especially if it were possible to get fixed income returns that are high enough to pay the annual income beneficiary distributions.

This dichotomy presents a dilemma for the investing trustee who has a fiduciary duty to protect the best interests of both beneficiaries. The tiered income distribution order, as described above compounds the potential conflict between the individual “lifetime” interest beneficiary and the charitable remainder interest beneficiary. If the trustee invests the trust only in fixed income investments, the income beneficiary will be taxed on all of the trust income distributions at the higher regular income tax rates. If the trustee invests only in equity investments, he can be criticized for risking the preservation of the principle that is so important to the remainder beneficiary charity. At the very least, a trustee would be prudent to balance these interests.

As noted above, however, section 664 requires that ordinary income be distributed first. Therefore, if the trustee attempts to balance trust investments between fixed income and growth (such as 50% growth and 50% fixed income) within a single CRT he runs the risk that distributions will be disproportionately designated as ordinary income. This would occur when the fixed income returns are greater than the required income distribution amount.

For example, a CRT containing $1 million may be required to pay 5% ($50,000) annually to the trust's income beneficiary. The trust may be invested 50%, or $500,000 in fixed income investment, and 50% or $500,000 in growth investments. Assuming that each type of investment generated an income of $50,000, the trust's fixed income return of $50,000 must be distributed first. Since $50,000 is the income distribution amount, the income beneficiary would have to treat his entire income distribution of $50,000 as ordinary income, taxed at more than twice the rate of capital gains.

The after-tax income is potentially maximized by designating at least a portion of income to be taxed as capital gains. Establishing a plurality of CRTs, with at least one CRT that generates growth from equity investments, distributions from which are taxed as capital gains income, may potentially balance the interests of the income beneficiary and the charitable remainder beneficiary. Currently, investment trustees, as well as grantors, income beneficiaries, and charitable remainder beneficiaries, lack the means to determine and evaluate the benefit of establishing multiple CRTs.

From the foregoing discussion, it should be apparent that a need exists for an apparatus, system, and method for determining and achieving a tax advantage through the specialized management of a plurality of charitable remainder trusts (CRTs). Beneficially, such an apparatus, system, and method would determine and evaluate the benefits of establishing a plurality of CRTs. In addition, the apparatus, system, and method would determine a recommended allocation of trust assets relative to a tax saving amount, to an investment type or risk benefit, and to the advantage of the grantor and/or beneficiaries.

### SUMMARY OF THE INVENTION

The present invention has been developed in response to the present state of the art, and in particular, in response to the problems and needs in the art that have not yet been fully solved by currently available apparatuses, systems, and methods for estimating after-tax income and achieving a tax advantage for income distributions from charitable remainder trusts (CRTs). Accordingly, the present invention has been developed to provide an apparatus, system, and method for determining a recommended allocation of trust assets to a plurality of CRTs that overcome many or all of the above-discussed shortcomings in the art. The plurality of trusts may subsequently be managed to achieve the desired tax benefits that have become evident from an analysis and comparison method.

The apparatus, in one embodiment, determines a projected income distribution for a plurality of trusts and determines and compares after-tax income generated for each of the plurality of trusts. In one embodiment, trusts include, but are not limited to, a class of CRT managed to generate ordinary income from fixed income investments, distributions from which are taxed as ordinary income; a class of CRT managed to generate growth from equity investments, distributions from which are taxed as capital gains income; and a class of CRT managed to generate tax free income or return of principle which is not taxable. In a further embodiment, trusts may further include a class of CRT (unitrust) managed to allocate income distributions according to a fixed percentage of the net fair market value of the invested trust assets; a class of CRT (annuity) managed to allocate income distributions according to a fixed dollar amount; and may include an insurance trust funded with a wealth replacement life insurance policy.

In one embodiment, the apparatus includes an input module that receives client input, a calculation module that determines the projected income distribution and a corresponding tax requirement for a plurality of CRTs, a comparison module that determines and compares after-tax income generated for each of the plurality of CRTs, and a recommendation module that provides a recommended allocation of trust assets to a plurality of CRTs. The comparison module may further determine a tax saving amount that indicates a preference of at least one class (management style) of CRT over another class of CRT. The apparatus facilitates determining a combination of trusts that provides the greatest tax advantage. In a further embodiment, the apparatus includes the client input in the determination process to determine the recommended allocation of trust assets.

The client, investing trustee, or the like may subsequently achieve the determined tax advantage by establishing a plurality of CRTs according to the recommended allocation of trust assets. In one embodiment, a recommended allocation of trust assets includes allocating a portion of the trust assets to a first CRT that is managed to generate ordinary income from fixed income investments, such that issuing income distributions are taxed as ordinary income; and allocating a portion of the trust assets to a second CRT that is managed to generate growth from equity investments, such that issuing income distributions are taxed as capital gains income. A further recommendation may include establishing an insurance trust and funding it with a wealth replacement life insurance policy. Another recommendation may include paying the premiums for the wealth replacement life insurance policy with CRT income distributions.

The input module of the apparatus, in one embodiment, receives client input including at least one parameter for determining a projected income distribution for a CRT and at least one client preference indicative of a risk-tolerance. As a result, an integration module may determine the risk tolerance of the client and integrate the risk tolerance into an indicator for determining the recommended allocation of trust assets to more than one CRT.

In certain embodiments, the recommended allocation may be weighted relative to an investment type and the indicator. In a further embodiment, the recommendation module identifies a recommended number of trusts that generates the greatest tax saving amount for income generated from trust assets. In one embodiment, a recommended management style establishes more than one CRT and manages trust assets such that a portion of the generated income may be taxed as capital gains income, which is taxed at a lower rate than regular income. Establishing and managing a plurality of trusts provides a tax advantage unavailable through the traditional method of allocating assets to a single CRT.

A system of the present invention is also presented to determine and achieve a tax advantage through the specialized management of a plurality of CRTs. In one embodiment, the system includes a computer network, a computer connected to the network, a server configured to communicate with the computer through the computer network and to search a database, an input module to receive client input, a calculation module to determine the projected income distribution and a corresponding tax requirement for a plurality of CRTs, a comparison module to determine and compare after-tax income generated for each of the plurality of CRTs, a recommendation module to provide a recommended allocation of trust assets, an interface module to display a visual comparison of the after-tax income generated for each of the plurality of CRTs, and a display device to display the visual comparison.

The system enables remote access to the calculation module, the recommendation module, and the comparison module through the computer network. In addition, the system may comprise a database that enables tax and trust information to be updated in order to provide an accurate estimate of projected income distributions and corresponding tax requirements. The system may be accessible to the client, investing trustee or the like to facilitate establishing and managing a plurality of trusts.

In a further embodiment, a method to determine and achieve a tax advantage through the specialized management of a plurality of CRTs may be substantially embodied in a computer program product. The operations of the computer program product may include receiving client input, the client input comprising at least one parameter for determining a projected income distribution for a CRT; determining the projected income distribution and a corresponding tax requirement for each of a plurality of CRTs; comparing after-tax income generated for each of the plurality of CRTs; and providing a recommended allocation of trust assets to a plurality of CRTs. In a further embodiment, the computer program product may include an operation to determine the risk tolerance of the client and to integrate the risk tolerance into an indicator for determining the recommended allocation of trust assets.

The method may further include allocating assets to a plurality of CRTs according to the recommended allocation and managing the CRTs to achieve the determined tax advantage. In one embodiment, at least one CRT is managed to generate growth from one or more equity investments.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention facilitates determining and comparing and subsequently achieving an after-tax income advantage through the specialized management of a plurality of CRTs. Beneficially, the present invention determines and evaluates the benefits of establishing a plurality of CRTs. In addition, the present invention recommends an allocation for trust assets relative to a tax saving amount and to the advantage of the grantor and beneficiaries. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an access system for determining and achieving a tax advantage through the specialized management of a plurality of CRTs in accordance with the present invention;

FIG. 2 is a schematic block diagram illustrating one embodiment of an apparatus for determining and achieving a tax advantage through the specialized management of a plurality of CRTs in accordance with the present invention;

FIG. 3 is a schematic block diagram illustrating an alternative embodiment of an apparatus for determining and achieving a tax advantage through the specialized management of a plurality of CRTs in accordance with the present invention;

FIG. 4 is a schematic block diagram illustrating one embodiment of an indicator in accordance with the present invention;

FIG. 5 is a schematic block diagram illustrating one embodiment of a recommended allocation of trust assets in accordance with the present invention;

FIG. 6 is a screen shot illustrating one embodiment of client input in accordance with the present invention;

FIG. 7 is a spreadsheet illustrating one embodiment of a projected income distribution for a Charitable Remainder Unitrust (CRUT) having a combination of trust assets as determined by the calculation module in accordance with the present invention;

FIG. 8 is a spreadsheet illustrating one embodiment of a projected income distribution for a fixed income investment CRT 1 as determined by the calculation module in accordance with the present invention;

FIG. 9 is a spreadsheet illustrating one embodiment of a projected income distribution for an equity investment CRT 2 as determined by the calculation module in accordance with the present invention;

FIG. 10 is spreadsheet illustrating a comparison between the projected income distribution for the CRUT having a combination of trust assets and a combined projected income distribution for the fixed income investment CRUT and the equity investment CRUT in accordance with the present invention; and

FIG. 11 is a flow chart diagram illustrating one embodiment of a method for determining and achieving a tax advantage through the specialized management of a plurality of CRTs in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of generating a signal, causing a signal to be generated, or causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

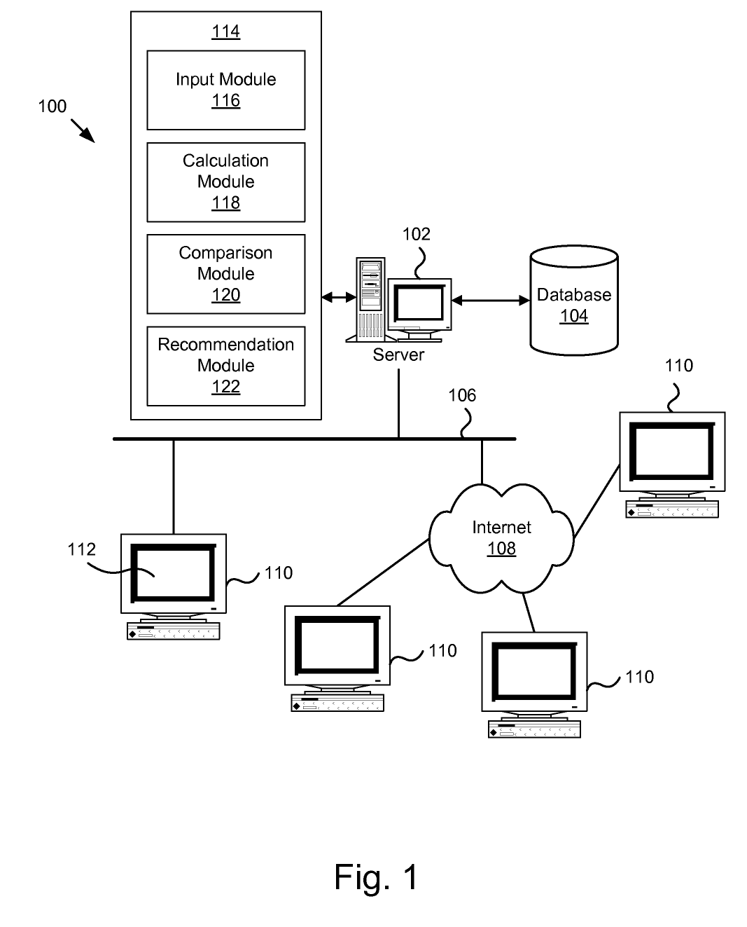

FIG. 1 depicts one embodiment of an access system 100 for determining and achieving a tax advantage through the specialized management of a plurality of CRTs in accordance with the present invention. The access system 100 may be embodied in a computer network 106, which may be accessible through one or more remote computers 110 or the like. The access system 100 may include a server 102, a database 104, a network 106, the Internet 108, computers 110, a display device 112, and a CRT recommendation apparatus 114. The CRT recommendation apparatus 114 may include an input module 116, a calculation module 118, a comparison module 120, and a recommendation module 122. The access system 100 enables a client or user to determine which trusts, including CRTs, offer the greatest tax advantage over a determined period of time.

The server 102 may be accessible to other computers 110 through the network 106 and/or the Internet 108 such as the World Wide Web. As a result, remote users may benefit from the CRT recommendation apparatus 114 through the network 106. In addition, the server 102 may access the database 104, which may be updated, for example, as information or tax laws change or rates fluctuate. Consequently, the client and/or the user, which may or may not be the same entity, may access current, accurate data regarding CRTs.

In one embodiment, the user is an investing trustee who enters the client input data into the CRT recommendation apparatus 114 in order to identify a recommended allocation of assets to a plurality of CRTs that provides the greatest tax advantage for the client. In an alternative embodiment, the client may be a grantor or the like who desires to transfer assets to one or more trusts. Alternatively, an income beneficiary or charitable remainder beneficiary may provide input to the CRT recommendation apparatus 114 and/or trustee to determine the most advantageous allocation of assets that benefits all parties involved.

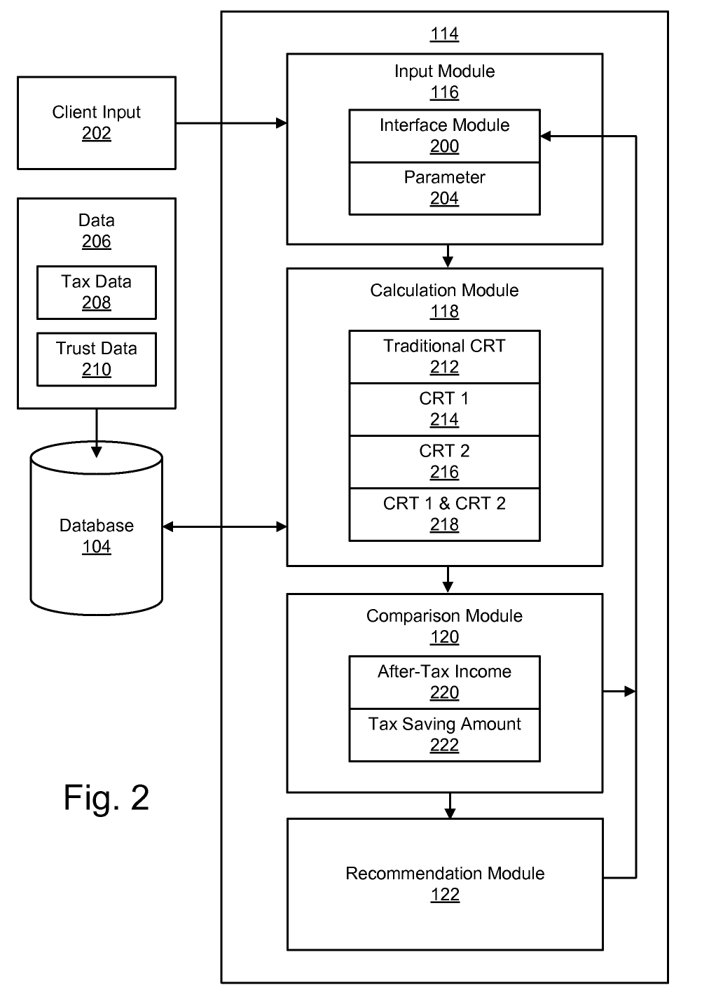

FIG. 2 illustrates in greater detail one embodiment of the CRT recommendation apparatus 114, which facilitates evaluating and determining one or more CRTs that provide the greatest tax advantage for its beneficiaries. The CRT recommendation apparatus 114, as depicted, includes an input module 116, a calculation module 118, a comparison module 120, a recommendation module 122, an interface module 200, and a database 104. In the depicted embodiment, the CRT recommendation apparatus 114 determines the projected income distribution and tax requirements for a plurality of CRTs and compares the results.

In certain embodiments, determining and comparing CRTs illustrate the advantages of establishing multiple classes of CRTs, or splitting an existing CRT into a plurality. Traditionally, typically only one CRT is established for a grantor and/or beneficiary. The CRT is commonly established as a fixed income investment and the distributions are taxed as ordinary income as described above.

Each CRT, however, may be classified or managed according to the manner of income generation; for example, as ordinary income or as capital gains income. Consequently, two or more CRTs may be created to maximize the ability of the income beneficiary to regard at least a portion of the income distribution as capital gains income.

For example, a $1,000,000 asset may be divided (split) with half the asset ($500,000) going into a first CRT (CRT 1) and the other half ($500,000) going into a second CRT (CRT 2). Each trust is required to pay $5% ($25,000) annually to the income beneficiary for a total annual distribution of $50,000. CRT 1 ($500,000) may be invested in fixed income investments, and CRT 2 ($500,000) may be invested in growth (equity) investments. Both trusts, and the investments therein, may be equally successful, the first achieving a 10% return, and the second, a growth of 10%. The trust income from CRT 1 continues to be taxed as ordinary income at 35%; however, the income from CRT 2 may be taxed as capital gains at only 15%. The tax reduction may be achieved while simultaneously realizing a balanced investment policy.

Establishing a plurality of CRTs potentially provides a tax advantage in any year of a CRT where fixed income returns are greater than the gains on equity investments. There may be years where the advantage does not materialize; though it is almost certain that there will be years where the advantage does materialize. Over time, the advantage is typically magnified and becomes more significant.

The CRT recommendation apparatus 114 may further facilitate determining a recommended allocation or division of the assets of an existing CRT such that a portion of the assets may be transferred into a new or separate CRT that continues to qualify as a CRT. The second CRT (CRT 2) may then be managed as a different investment class than the CRT 1 to achieve the benefits described above.

Furthermore, the CRT recommendation apparatus 114 may facilitate determining a recommended division or portion of income to be taxed as ordinary income versus capital gains by determining and evaluating the projected benefit(s) for a combination of CRTs. In one embodiment, a recommended allocation of assets dedicates funding to each class of CRT (CRT 1 and CRT 2).

In most cases, the establishment of a CRT is not contingent on the investment trends of the moment. Donors typically do not delay CRT establishment until interest rates are high. Moreover, even today the diligent investigator can find safe, high income yielding, fixed income investments ranging from 10% to 14%. Furthermore, the opportunity to compensate for low fixed income rates by generating tax savings through diversification into higher yield investments may provide additional incentive for CRT creation in any market.

In one embodiment, the input module 116 receives client input 202, which, as discussed above, may reflect the input of one or more clients and may be entered by an investing representative in certain embodiments. Additionally, the client input 202 may be used to determine at least one parameter 204 for determining a projected income distribution.

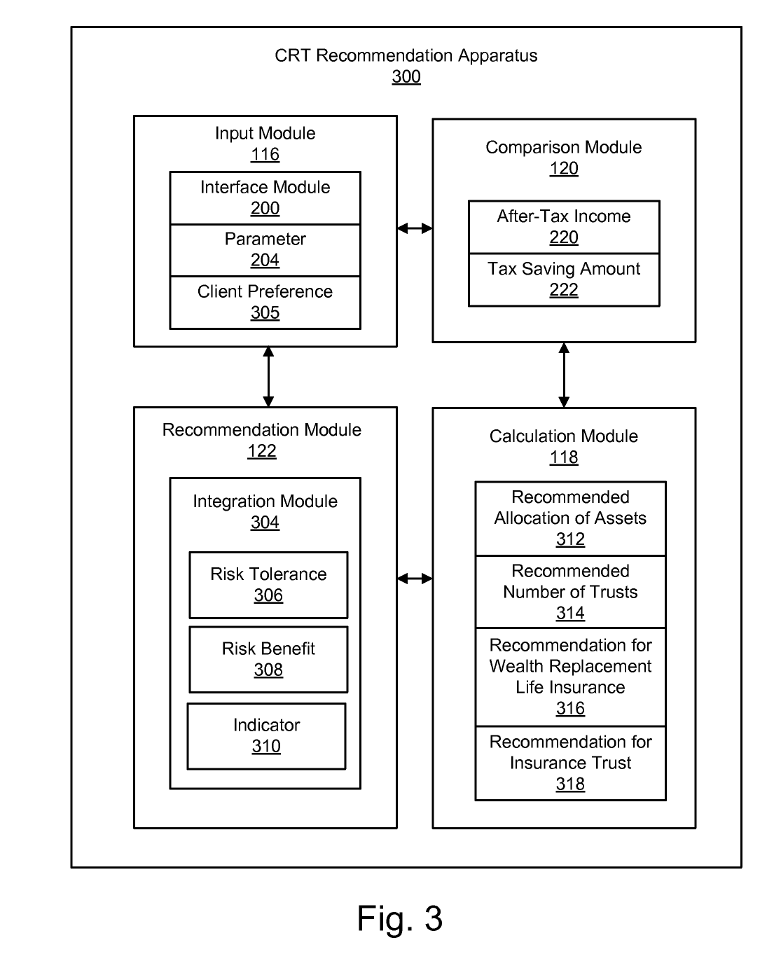

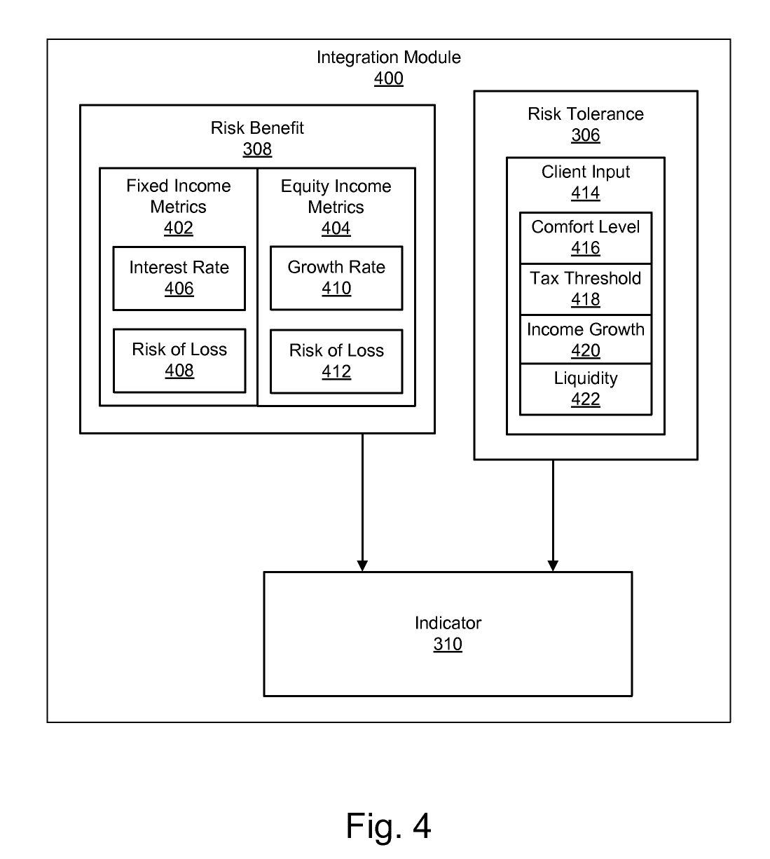

The interface module 200 prompts the client or user to provide the client input 202 in certain embodiments. For example, the interface module 200 may display a series of questions to be answered. The client responses may in turn be used to determine a recommended allocation of assets to a plurality of CRTs. Parameters 204 might include, but are not limited to: the value of the assets available to create one or more trusts, tax rate information, expected returns, and the like. In one embodiment, the interface module 200 may further prompt for information reflecting the risk tolerance of the client, which will be discussed in greater detail with respect to FIGS. 3-4.

The calculation module 118 receives client input 202 from the input module 116 and, in certain embodiments, input from the database 104. As mentioned, the database 104 may be continuously updated with data 206, including, but not limited to, tax data 208 and trust data 210. In the depicted embodiments, the calculation module 118 determines the income distribution and the corresponding tax requirement for a plurality of CRTs, including a traditional or combined income investment CRT 212, a fixed income investment trust (CRT 1) 214, an equity investment trust (CRT 2) 216, and a combination 218 of CRT 1 and CRT 2.

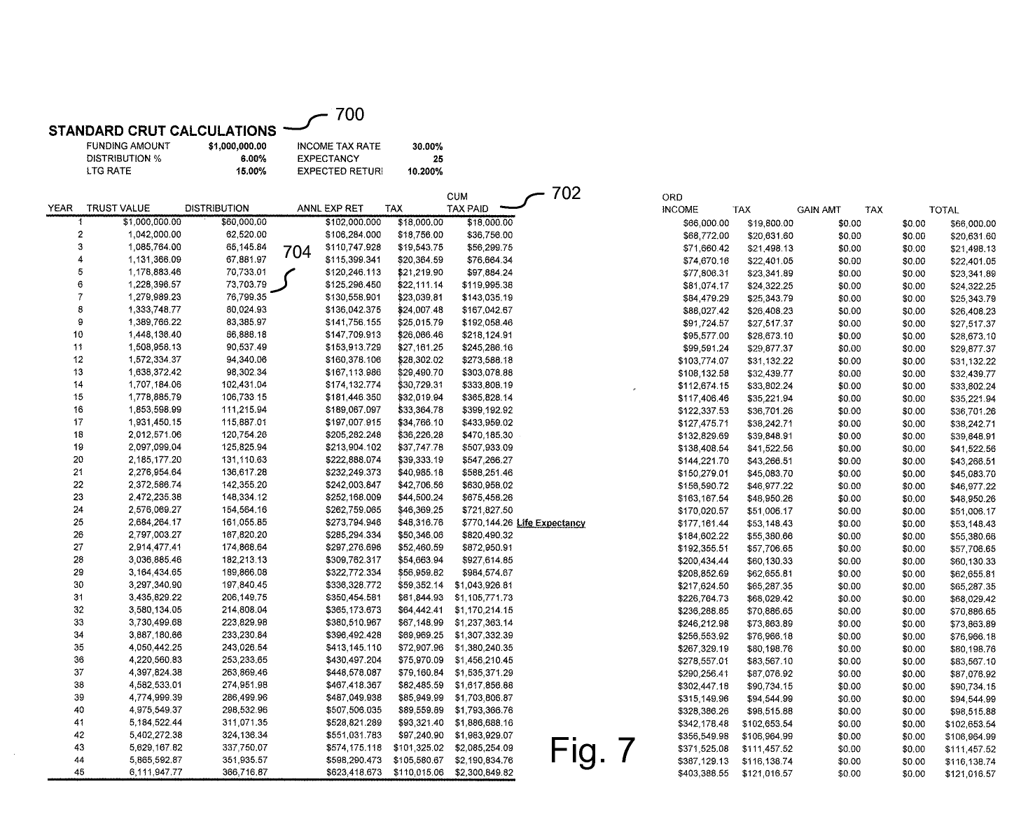

The asset value as well as the investment type and expected return may facilitate calculating a year-by-year schedule of the projected investment growth, income distribution, and corresponding tax requirement. In certain embodiments, the client indicated tax rate is used to calculate the tax required for a yearly income distribution. FIGS. 7-10 illustrate in greater detail a calculated income distribution for the listed CRTs 212, 214, 216, 218 respectively. Those of skill in the art will recognize that a calculation module 118 may be configured to perform multiple calculations for various input, investments, and designated trusts, and is not, therefore, limited to the illustrated embodiments.

The comparison module 120 may subsequently determine and compare an after-tax income 220 and a tax saving amount 222 for each of the plurality of CRTs. In one embodiment, the comparison module 120 creates a chart, illustration, or the like visually illustrating trust information, such as the annual value of the trust, the projected income distribution, taxes due, and accumulated taxes paid, for example, to facilitate determining which trust or combination of trusts provides the greatest tax advantage. In certain embodiments, a preferred combination of trusts may even provide investment growth advantages.

In one embodiment, the illustration depicts the traditional CRT 212 as compared to other classes of CRTs 214, 216, 218. In a further embodiment, the visual comparison indicates a tax saving amount 222, if any exists. The tax saving amount 222 and/or the after-tax income 220 may be indicated annually for the lifetime of the trust and may indicate a preference for at least one class of CRT over another class of CRT. In one embodiment, the combination 218 of the CRT 1 and the CRT 2 is more favorable than the traditional CRT 212.

The recommendation module 122 may receive input from the input module 116, the calculation module 118, and/or the comparison module 120. The recommendation module 122 provides a recommended allocation of assets to the user and other recommendations if applicable. In the depicted embodiment, the recommendation module 122 provides the recommendation(s) to the interface module 200. In one embodiment, the recommended allocation of assets comprises allocating a portion of the assets to a first CRT (CRT 1) that is managed to generate ordinary income from fixed income investments, such that issuing income distributions are taxed as ordinary income; and allocating a portion of the assets to a second CRT (CRT 2) that is managed to generate growth from equity investments, such that issuing income distributions are taxed as capital gains income. In a further embodiment, the recommendation module 122 may calculate and recommend a percentage of assets to be allocated to each class of CRT.

In one embodiment, the interface module 120 displays the visual comparison or illustration to the user. The user may be allowed to enter additional input or change parameters 204 to determine an alternative trust strategy, such as asset values, preferences, number of CRTs, or the like, which may better conform to the client's needs.

FIG. 3 illustrates an alternative embodiment of a CRT recommendation apparatus 300 in accordance with the present invention. The CRT recommendation apparatus 300 may include an input module 116, an interface module 200, a recommendation module 122, an integration module 304, a calculation module 118, and a comparison module 120. The input module 116 may be similar to the input module 116 illustrated in FIG. 2; however, the input 202 may be further tailored to include one or more client preferences 305 indicative of a risk tolerance 306. The client preference 305 may facilitate determining the client's level of risk aversion and may facilitate forming a recommendation for the investment trusts.

Those experienced in the art will recognize that a younger, more risk-tolerant individual in a high income bracket may prefer higher risk investing with lower taxation, such as the equity investing CRT; while an older, more risk-adverse individual in a lower tax bracket may choose to focus on lower risk, although more highly taxed, investments, such as the fixed income investing CRT. Determining the preferences 305 of the investor/grantor may facilitate determining an appropriate allocation of trust assets.

In one embodiment, the input module 116, in conjunction with the interface module 200, receives input indicating the client's attitudes, needs, and desires in order to identify an apposite risk level, which may subsequently be used to achieve a desired tax advantage. The input module 116 enables the CRT recommendation apparatus 300 to respond to the priorities and circumstances of the individual beneficiaries. In certain embodiments, the CRT recommendation apparatus 300 may be used to balance an investment policy and management approach as mentioned above.

In the depicted embodiment, the integration module 304 determines the risk tolerance 306 from the client preference(s) 305 and integrates the risk tolerance 306 into an indicator 310 for determining a recommended allocation 312 of assets. The integration module 304 may further determine a risk benefit 308 that may also be integrated into the indicator 310. In one embodiment, the risk benefit 308 is determined from one or more parameters 204. The risk tolerance 306 and risk benefit 308 are illustrated in greater detail in FIG. 4.

The recommendation module 122 may determine the recommended allocation 312 of trust assets, in certain embodiments, and communicate the specifications to the calculation module 118 to determine a projected income distribution and/or the like. In one embodiment, the recommended allocation 312 of trust assets is determined from client input 202 and from stored data 206. In a further embodiment, the recommended allocation 312 is weighted relative to an investment type, such as fixed income or equity, for example, and the indicator 310.

In addition, the recommended allocation 312 of trust assets may include distributing trust assets into a plurality of CRTs, wherein at least one CRT is configured to generate growth from one or more equity investments. Furthermore, the recommendation module 122 may identify a recommended number 314 of trusts and/or types of investments within the trusts that generate the greatest tax saving amount for income generated from trust assets. In particular, a portion of the generated income may be taxed as regular income and a portion of the income may be taxed as capital gains income for greater tax saving. The percentage of trust income taxed as regular income versus capitol gains may be controlled by selecting the optimal percentage of assets to be invested in each class of CRT.

In one embodiment, recommendations for trust investments are restricted to Charitable Remainder Trusts as defined in Section 664 of the Internal Revenue Code relative to charitable planning models. The recommended number 314 of trusts may include creating two or more CRTs that each receive a proportion of the assets that would have gone into, or were in one CRT, and then managing one of the trusts in a way that maximizes fixed income or ordinary income, and managing the second trust in a way that maximizes equity or long term capital gain growth (realized or unrealized). In certain cases, there may be a need for a third and fourth trust, managing the third trust (if there is a third) in a way that maximizes tax free income, and managing a fourth trust in a way that maximizes return of principle.

For practical reasons, the split recommendation, in most cases, typically only involves the first two trusts, CRT 1 and CRT 2. In the case where appreciated assets are being transferred to a CRT and are then sold, there is a large accumulated capital gain on the books of the trust that will minimize any opportunity to benefit from the investment of tax free bonds or to obtain a return of principle. For this reason, the following description of this patent will focus on the management of the two classes of trusts, CRT 1 and CRT 2.

In one embodiment, the recommendation module 122 may further determine a recommendation 316 to purchase a wealth replacement insurance policy on the life of the grantor and paying the premiums for the insurance policy from CRT income distributions. In addition, the recommendation module 122 may further determine a recommendation 318 for establishing an insurance trust and funding it with the wealth replacement life insurance policy. Such a recommendation may benefit the charitable remainder beneficiary as well as the estate of the grantor, while providing beneficial tax advantages.

The calculation module 118 may calculate the projected value, growth, and income distributions for the recommended allocation 312 of assets and number 314 of trusts. The calculation module 118 may further determine the potential value and cost of wealth replacement life insurance 316 as well as establishing an insurance trust 318. The calculation module 118 may be configured to determine numerous calculations and/or estimations in order to facilitate determining and comparing after-tax income generated for a plurality of trusts.

The comparison module 120 may create an illustration comparing the benefits, after-tax income 220 and tax saving amount 222 for the recommendations 312, 314, 316, 318. In addition, the traditional CRT 212 may be included in the visual comparison to emphasize the benefits of the recommendations 312, 314, 316, 318. Those of skill in the art will recognize that benefits of the invention may be realized using variations of the illustrated embodiments. The present invention is not, therefore, limited to the depicted embodiments.

FIG. 4 illustrates one embodiment of an integration module 400 and an indicator 310 in accordance with the present invention. The indicator 310 may comprise a combination of input from the risk benefit 308 and the risk tolerance 306. The risk benefit 308, as depicted, may be determined by comparing fixed income metrics 402 and equity income metrics 404. The fixed income metrics 402 may include an interest rate 406 and a risk of loss 408, which may be compared to a growth rate 410 and a risk of loss 412 for an equity investment. Typically, the risk of loss 408 for fixed income investments tends to be lower than the risk of loss 412 for equity income investments; however, the interest rate 406 may be set and may limit the growth of the investment. On the other hand, the growth rate 410 of equity investments may be relatively limitless, but is accompanied by the higher risk of loss 412 or possible negative growth 410.

In certain embodiments, the risk benefit 308 may be determined by the current market and interest rates, or by particular investments and projected potentials. Alternatively, the risk benefit 308 may be a set dichotomy that is standard for all investments. In one embodiment, the risk benefit 308 recommends placing fifty percent of assets into each type of investment, fixed income and equity.

The risk benefit 308 may consequently be balanced by the risk tolerance 306 of the client. Client input 414 may include, but is not limited to, a comfort level 416, a desired tax threshold 418, a desired income growth 420, and liquidity 422 of the investment. If a client is comfortable with high risk, for example, the risk tolerance may indicate a greater investment and/or allocation of assets to equity income investments. Alternatively, if the client is risk adverse and is comfortable paying a higher tax rate on a guaranteed increase, the risk tolerance 306 may indicate a greater investment and/or allocation of assets to fixed income investments.

The indicator 310 beneficially reflects the data from both aspects, from the market value of the risk benefit 308 and from the client's risk tolerance 306. Furthermore, the indicator 310 consequently enables the recommendation module 122 to provide one or more recommendations that reflects both the market and the client, which may facilitate maximizing the growth potential of the investments while taking into account the personality and desires of the client.

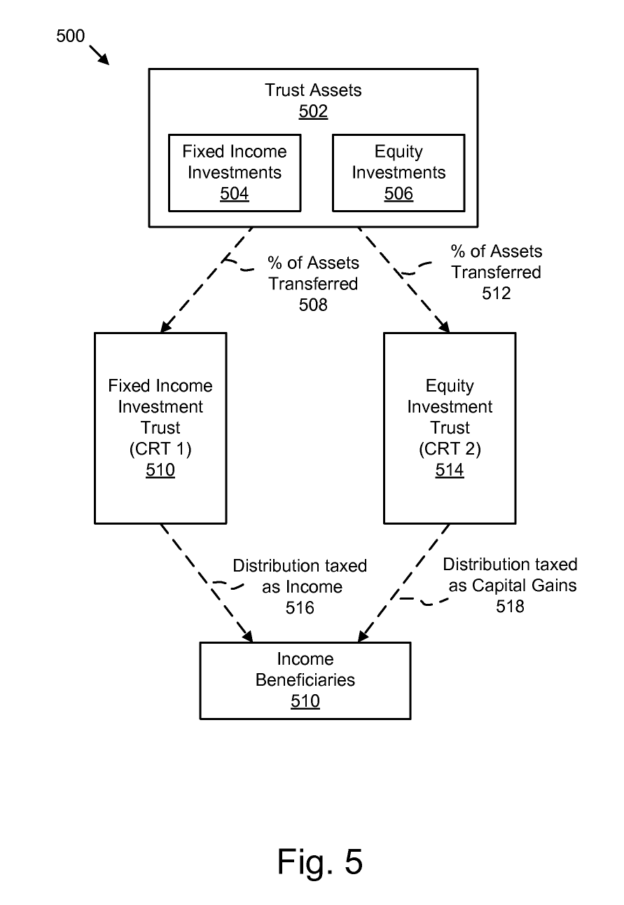

FIG. 5 illustrates one embodiment of a recommended allocation 500 of trust assets 502 in accordance with the present invention. In one embodiment, the recommended allocation 500 determines what percentage of trust assets 502, which may or may not include both fixed income investments 504 and equity investments 506, should be allocated to which class of CRTs. In the depicted embodiment, a percentage 508 of the trust assets 502 are transferred to a fixed income investment trust 510 (CRT 1), while a percentage 512 of the trust assets are transferred to an equity investment trust 514 (CRT 2).

Income distributions 516 from the CRT 1 510 are consequently taxed as ordinary income 516, which is typically a higher rate than the income distributions 518 that are taxed as capital gains. As a result, the income beneficiary 510 is guaranteed that at least a portion of the income 518 is taxed at the lower tax rate for capital gains. Beneficially, the investments or trust assets 502 remain balanced between fixed income investments 504 and equity investments 506, which lower the risk of loss for the overall investment.

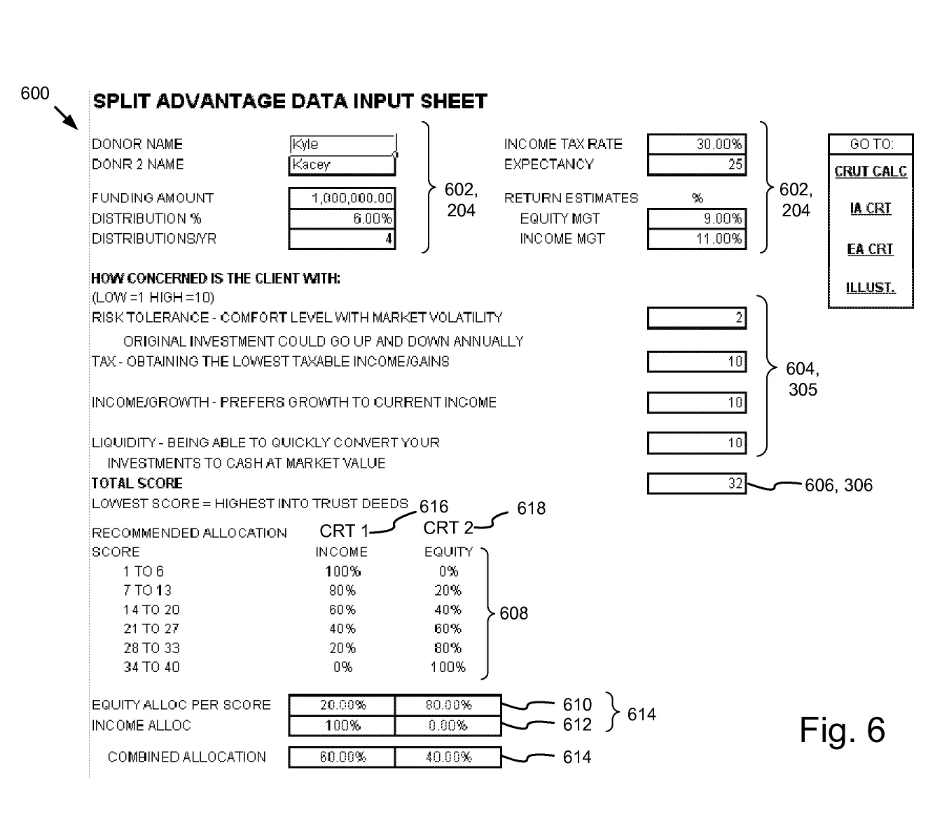

FIG. 6 is a screen shot illustrating one embodiment of client input 600 in accordance with the present invention, which may be received into the input module 116 as discussed. The interface module 200, in certain embodiments, may provide the structure for receiving the input 600.

In order to define the value and parameters of one or more trusts, the client may provide general data 602 describing the client as well as specific parameters 204 reflecting the trust assets and desired trust(s). In the depicted embodiment, the general data 602 includes the name of the donor(s), the amount of the trust, the donor's income tax rate, the distribution percentage, the distribution frequency, and the life expectancy of the donor(s). In addition, the general data 602 may include the expected return for the managed income investment(s) and the managed equity investment(s).

Subsequently, a series of questions 604 soliciting client preferences 305 may facilitate determining the risk tolerance 306 of the client. As discussed, the risk tolerance 306 may reflect the comfort level of the client, desired tax threshold, income growth, liquidity of the investments, and the like. In the depicted embodiment, each response is a number between 1 and 10, indicating the client's level of concern in the identified sphere of risk. Each response 305 may be added to determine a total sum 606, which may indicate the risk tolerance 306 in certain embodiments.

A chart or model 608, in certain embodiments, provides a recommended allocation of assets that integrates the risk benefit 308 with the risk tolerance 306. The integration module 304 may determine an indicator 610 reflecting both types of risk input. In the depicted embodiment, the indicator 610 further indicates a distribution of equity assets to a class of trust, CRT 1 616 and CRT 2 618.

The recommendation module 122 may subsequently determine a recommended allocation 614 of trust assets and/or a recommended number of trusts by weighing the indicator 610 and an investment type 612. In the depicted embodiment, the investment type 612 comprises an allocation for split (50/50) investment in both fixed income and equity investments. All of the fixed income investments may be allocated to CRT 1 to preserve the advantage of taxing income distributions from CRT 2 as capital gains. To determine the recommended allocation 614 of assets for each type of trust, CRT 1 and CRT 2, the individual results for the indicator 610 and the investment type 612, as depicted, may be multiplied by one half and added together to indicate distribution of all of the trust assets.

The determined recommendations 614 and the general data 602 may be used to determine an estimated yearly income distribution and tax requirement for a plurality of trusts as discussed above, particularly in relation to FIG. 2. In one embodiment, the input and recommendations may be used to determine a traditional CRT 212, a CRT 1 214, a CRT 2 216, and a combination 218 of the CRT 1 and the CRT 2.

FIG. 7 is a spreadsheet illustrating one embodiment of a projected income distribution 700 for a Charitable Remainder Unitrust (CRUT) (or traditional CRT 212) having a combination of trust assets, income and equity. The calculation module 118 may use the input 202, such as the beginning asset value ($1,000,000), tax rate (30%), expected return (10.200%), distribution percentage (6%), and the like, to determine the income distribution 704 and the tax requirement 702 paid on the distribution 704. Because the asset value includes multiple investment types, income distributions 704 are allocated first from the interest gained on fixed income investments, which are taxed as ordinary income. Consequently, the income beneficiary may never benefit from the lower tax rate for capital gains.

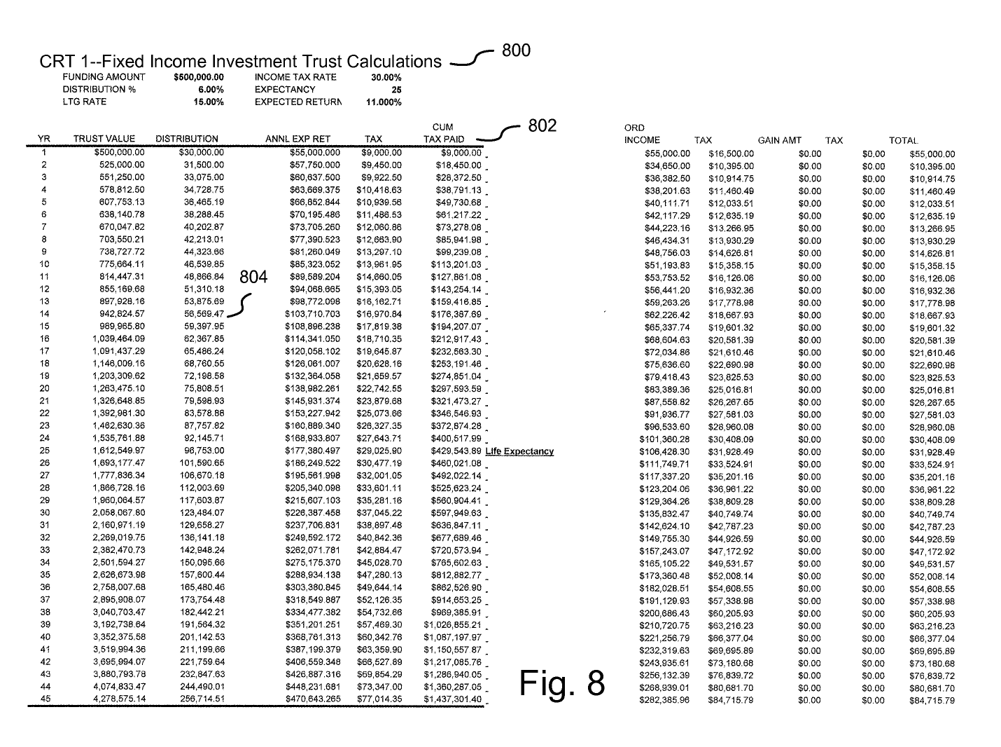

FIG. 8 is a spreadsheet illustrating one embodiment of a projected income distribution 800 for a fixed income investment CRUT (or CRT1 214) as determined by the calculation module 118 in accordance with the present invention. In the depicted embodiment, half of the original value of the trust ($500,000) is allocated to the fixed income investment trust CRT 1, which may comprise both fixed income investments and equity investments in certain embodiments. As a result, the tax requirement 802 is determined for the income tax paid on the income distributions 804 similar to the CRUT illustrated in FIG. 7. However, the tax requirement for the CRT 1 as calculated is less than the overall tax requirement for the combined CRUT because of the lower overall value of the trust.

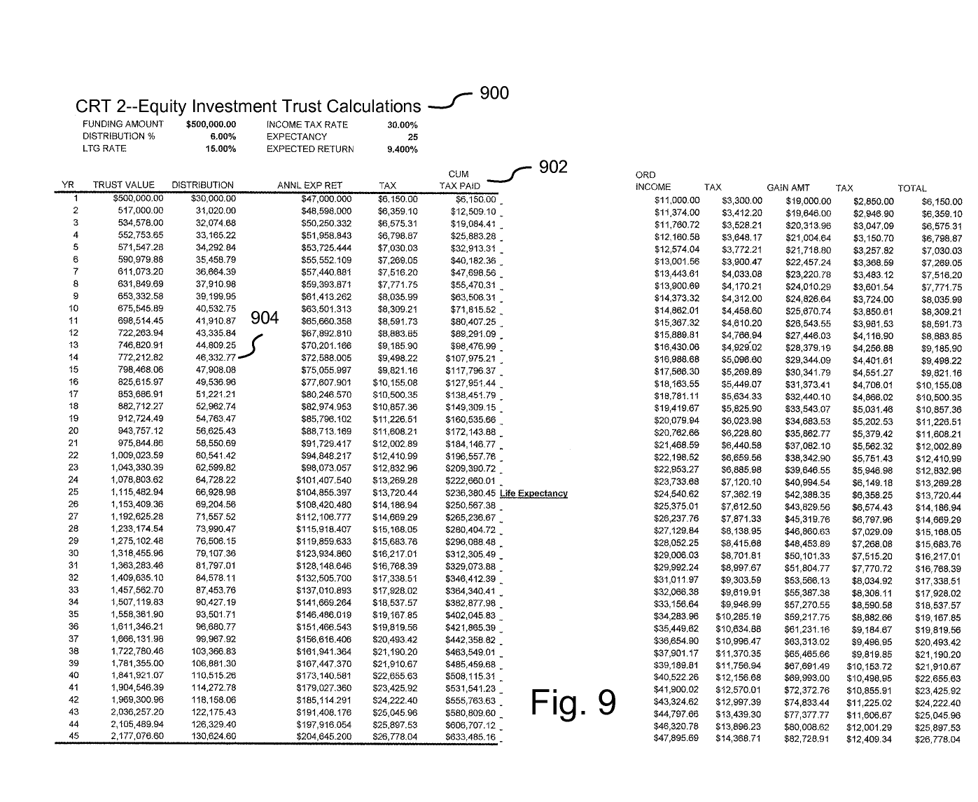

FIG. 9 is a spreadsheet illustrating one embodiment of a projected income distribution 900 for an equity investment CRUT (or CRT 2 216) as determined by the calculation module 118 in accordance with the present invention. Similarly, half the value of the original trust 700 is allocated to the equity investment trust CRT 2. The CRT 2, however, includes equity investments only. As a result, the tax requirement 902 is calculated as capital gains tax for the income distribution 904. As illustrated, the tax requirement 902 is less than the tax requirement 802 for the CRT 1 illustrated in FIG. 8.

In addition, dividing the original trust enables a portion of the equity investment to be distributed and taxed accordingly. Because the expected return is lower for the equity investment than for the income investment, the division may facilitate retaining a greater amount of fixed income principle in the CRT 1, which gains a greater expected return than would be possible for the traditional CRT 212.

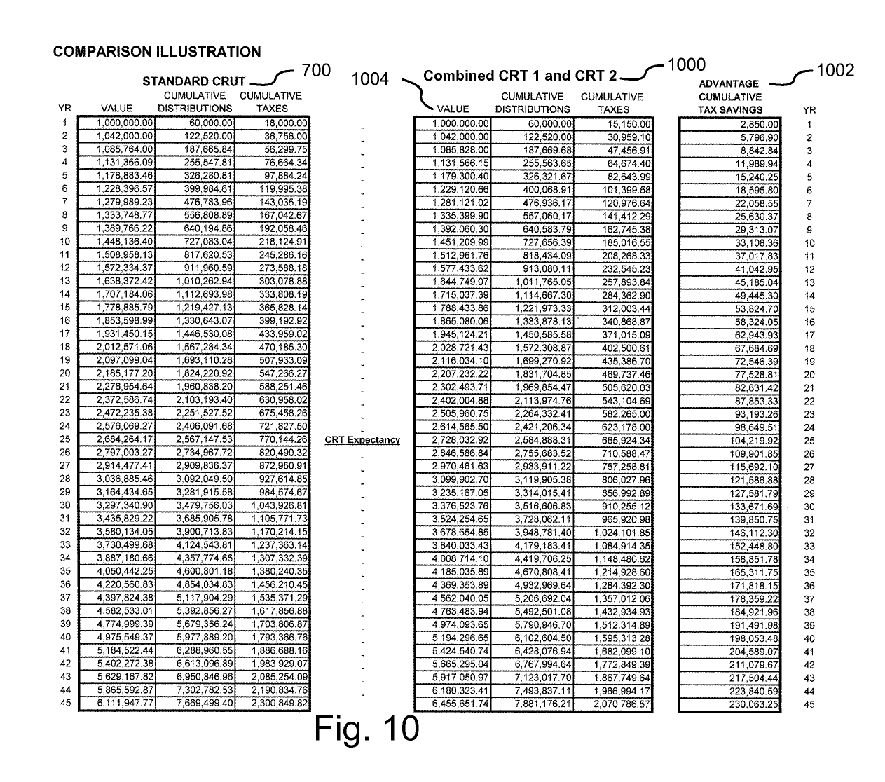

FIG. 10 is a spreadsheet illustrating a comparison between the traditional CRUT 700 and a split combination 1000 of the CRT 1 and the CRT 2. Both classes of CRTs illustrate an asset value beginning at $1,000,000. Creating an equity investment CRT 2 provides a tax savings amount 1002 that is amplified as the value of the trust assets increases. In certain embodiments, the comparison module 120 determines and compares the after-tax income generated for each of the plurality of CRTs and further determines the tax saving amount 1002, which may indicate a preference for the combination of CRTs 1000 over the standard CRUT 700 as depicted. In addition, the comparison module 120 and/or the interface module 200 may present the results to the user.

Overtime, the combination of CRTs 1000 not only provides a tax saving advantage 1002, but also provides an increase in the overall value of the trust assets 1004, which is eventually distributed to the charitable remainder beneficiary. Thus, the income beneficiary and the charitable remainder beneficiary simultaneously benefit from establishing a plurality of CRTs.

Visually comparing trusts or combinations of trusts, such as CRTs, illustrates the advantages of choosing one or more classes of trusts over another class of trust. In the depicted embodiment, the traditional CRUT provides fewer advantages than the combination of the CRT 1 and CRT 2. In addition, the visual comparison enables the client, whether the charitable remainder beneficiary, the income beneficiary, and/or the donor, to determine the best strategy for allocating assets to one or more trusts that benefit all involved.

In the depicted embodiments, the income distributions are calculated for a unitrust that allocates income distributions according to a fixed percentage of the net fair market value on the invested trust assets. Those of skill in the art will recognize that annuity trusts, which are configured to allocate income distributions according to a fixed dollar amount, may also benefit from and be included in the calculations, determinations, and comparisons of the present invention.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Additionally, the order in which a particular method occurs may or may not strictly adhere to the order of the corresponding steps shown.

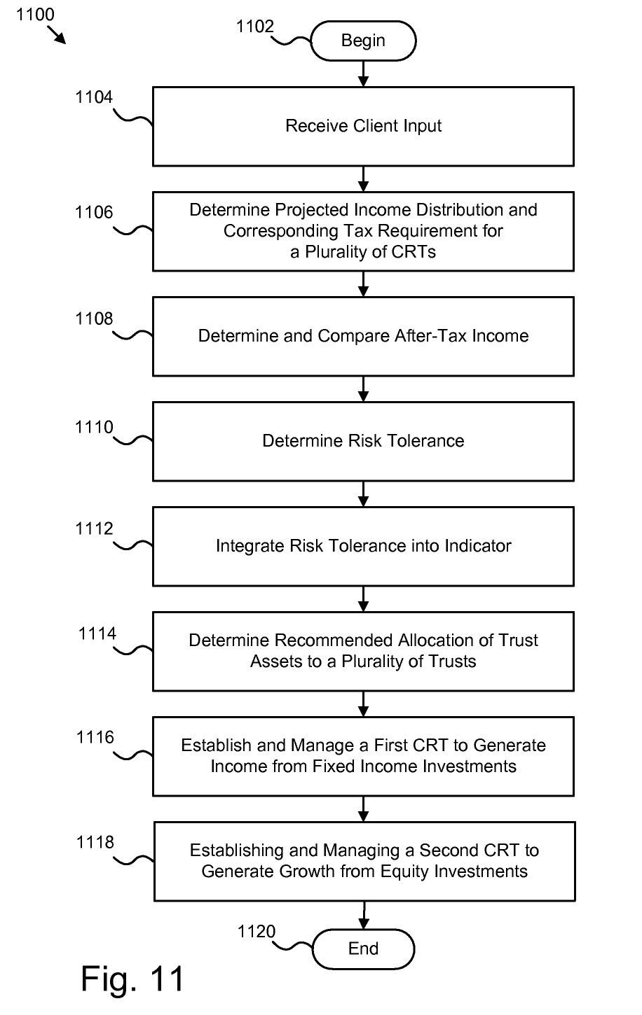

FIG. 11 illustrates one embodiment of a method 1100 for determining and achieving a tax advantage through the specialized management of a plurality of CRTs. The method 1100 may begin 1102 and may include receiving 1104 client input, determining 1106 a projected income distribution and corresponding tax requirement for a plurality of CRTs, determining 1108 and comparing after-tax income for the plurality of CRTs, determining 1110 a risk tolerance, integrating 1112 the risk tolerance into an indicator, and determining 1114 a recommended allocation of trust assets from the indicator and an investment type. Subsequently, the client or the like may establish 1116 and manage a first CRT to generate income from fixed income investments and establish 1118 and manage a second CRT to generate growth from equity investments. The plurality of CRTs may be established according to the recommended allocation determined by the recommendation module 122. Then the method 1100 ends 1116.

Integrating 1112 the risk tolerance into the indicator facilitates personalizing a recommendation for a particular client. Furthermore, determining 1114 a recommended distribution of trust assets and comparing 1110 the after-tax income of a plurality of CRTs may enable the client to select a plurality of CRTs that benefits both the income beneficiary and the charitable remainder beneficiary. The tax advantage is obtained by establishing 1118 a plurality of CRTS and managing at least one of the CRTs to generate income from equity investments that can be taxed as capitals gains.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for determining and achieving a tax advantage through the specialized management of a plurality of charitable remainder trusts (CRTs), the apparatus comprising:
a comparison module configured to compare after-tax income generated for each of a plurality of CRTs, wherein at least one CRT is selected from a class of CRTs managed to generate growth from one or more equity investments; and
a recommendation module configured to provide a recommended allocation of trust assets to a plurality of CRTs, wherein at least one CRT is managed to generate growth from one or more equity investments such that issuing income distributions are taxed as capital gains income.

2. The apparatus of claim 1, further comprising an input module configured to receive client input, the client input comprising at least one parameter for determining a projected income distribution for a CRT.

3. The apparatus of claim 2, further comprising a calculation module configured to calculate the projected income distribution and a corresponding tax requirement for each of the plurality of CRTs.

4. The apparatus of claim 1, wherein the input module is further configured to receive client input comprising at least one client preference indicative of a risk-tolerance.

5. The apparatus of claim 4, further comprising an integration module configured to determine the risk tolerance of the client and to integrate the risk tolerance into an indicator for determining the recommended allocation of trust assets.

6. The apparatus of claim 5, wherein the integration module is further configured to determine a risk benefit for at least one of a fixed income investment and an equity investment, and wherein the integration module is configured to integrate the risk benefit into the indicator.

7. The apparatus of claim 6, wherein the indicator is a determined balance between the risk tolerance and the risk benefit, wherein low-risk fixed income investments are balanced with higher risk equity investments.

8. The apparatus of claim 5, wherein the recommendation module is further configured to determine the recommended allocation of trust assets, wherein the recommended allocation is weighted relative to an investment type and the indicator.

9. The apparatus of claim 1, wherein the recommendation module is further configured to identify a recommended number of CRTs that generate the greatest tax saving amount for income generated from trust assets, wherein a portion of the generated income is taxed as regular income and a portion of the income is taxed as capital gains income.

10. The apparatus of claim 1, wherein the recommendation module is further configured to determine a recommendation for purchasing a wealth replacement insurance policy on the life of the grantor and paying the premiums from CRT income distributions.

11. The apparatus of claim 10, wherein the recommendation module is further configured to determine a recommendation for establishing an insurance trust and funding it with the wealth replacement life insurance policy.

12. The apparatus of claim 1, wherein the plurality of trusts are selected from the group consisting of: a class of CRT managed to generate ordinary income from fixed income investments, distributions from which are taxed as ordinary income; a class of CRT managed to generate growth from equity investments, distributions from which are taxed as capital gains income; a class of CRT configured to generate tax free income or return of principle which is not taxable; a class of CRT (unitrust) managed to allocate income distributions according to a fixed percentage of the net fair market value of the invested trust assets; a class of CRT (annuity) managed to allocate income distributions according to a fixed dollar amount; and an insurance trust funded with a wealth replacement life insurance

13. A computer-oriented method for determining and achieving a tax advantage through the specialized management of a plurality of charitable remainder trusts (CRTs), the method comprising:
comparing after-tax income generated for each of a plurality of CRTs, wherein at least one CRT is selected from a class of CRTs managed to generate growth from one or more equity investments; and
providing a recommended allocation of trust assets to a plurality of CRTs, wherein at least one CRT is managed to generate growth from one or more equity investments such that issuing income distributions are taxed as capital gains income.

14. The method of claim 13, further comprising establishing and managing a first CRT to generate income from fixed income investments and establishing and managing a second CRT to generate growth from one or more equity investments, distributions from which are taxed as capital gains income.

15. The method of claim 13, further comprising receiving client input, the client input comprising at least one parameter for determining a projected income distribution for a CRT and determining a projected income distribution and a corresponding tax requirement for each of the plurality of CRTs.

16. The method of claim 13, further comprising determining the risk tolerance of the client and integrating the risk tolerance into an indicator for determining the recommended allocation of trust assets, wherein the indicator is a determined balance between the risk tolerance and a risk benefit achieved by balancing fixed-income investments with equity investments.

17. A computer program product comprising a computer readable medium having computer usable program code programmed for determining and achieving a tax advantage through the specialized management of a plurality of charitable remainder trusts (CRTs), the operations of the computer program product comprising:
comparing after-tax income generated for each of a plurality of CRTs, wherein at least one CRT is selected from a class of CRTs managed to generate growth from one or more equity investments; and
providing a recommended allocation of trust assets to a plurality of CRTs, wherein at least one CRT is managed to generate growth from one or more equity investments such that issuing income distributions are taxed as capital gains income.

18. The computer program product of claim 14, wherein the instructions further comprise an operation to receive client input, the client input comprising at least one parameter for determining a projected income distribution for a CRT and to determine a projected income distribution and a corresponding tax requirement for each of the plurality of CRTs.

19. The computer program product of claim 18, wherein the client input further comprises at least one client preference indicative of a risk tolerance and wherein the instructions further comprise an operation to determine the risk tolerance of the client and to integrate the risk tolerance into an indicator for determining the recommended allocation of trust assets.

20. The computer program product of claim 17, wherein the instructions further comprise an operation to determine the recommended allocation of trust assets, wherein the recommended allocation is weighted relative to an investment type and the indicator.

21. An apparatus for determining and achieving a tax advantage through the specialized management of a plurality of charitable remainder trusts (CRTs), the apparatus comprising:
a comparison module configured to compare after-tax income generated for each of a plurality of CRTs, wherein at least one CRT is selected from a class of CRTs managed to generate growth from one or more equity investments;
a recommendation module configured to provide a recommended allocation of trust assets to a plurality of CRTs, wherein at least one CRT is managed to generate growth from one or more equity investments such that issuing income distributions are taxed as capital gains income;
an input module configured to receive client input, the client input comprising at least one parameter for determining a projected income distribution for a CRT and at least one client preference indicative of a risk-tolerance;
a calculation module configured to determine the projected income distribution and a corresponding tax requirement for each of the plurality of CRTs; and
an integration module configured to determine the risk tolerance of the client and to integrate the risk tolerance into an indicator for determining the recommended allocation of trust assets; and
wherein the recommendation module is configured to determine the recommended allocation of trust assets and wherein the recommended allocation is weighted relative to a income type and the indicator.

22. A system for determining and achieving a tax advantage through the specialized management of a plurality of charitable remainder trusts (CRTs), the system comprising:
a computer network;
a computer connected to the network;
a server configured to communicate with the computer through the computer network and to reference a database;
a comparison module configured to compare after-tax income generated for each of a plurality of CRTs, wherein at least one CRT is selected from a class of CRTs managed to generate growth from one or more equity investments;
a recommendation module configured to provide a recommended allocation of trust assets to a plurality of CRTs, wherein at least one CRT is managed to generate growth from one or more equity investments such that issuing income distributions are taxed as capital gains income;
an input module configured to receive client input, the client input comprising at least one parameter for determining a projected income distribution for a CRT;
a calculation module configured to determine the projected income distribution and a corresponding tax requirement for each of the plurality of CRTs;
an interface module configured to display a visual comparison of the after-tax income generated for each of the plurality of CRTs; and
a display device configured to display the visual comparison.
